(19) United States
(12) Patent Application Publication
(10) Pub. No.: US 2013/0222279 A1
(43) Pub. Date: Aug. 29, 2013

(54) TOUCH DISPLAY APPARATUS

(71) Applicants: Chih-Wei Chang, Taoyuan County (TW); Shu-Wen Chang, Taoyuan County (TW); Chia-Chun Fang, Taoyuan County (TW)

(72) Inventors: Chih-Wei Chang, Taoyuan County (TW); Shu-Wen Chang, Taoyuan County (TW); Chia-Chun Fang, Taoyuan County (TW)

(73) Assignee: CHUNGHWA PICTURE TUBES, LTD., Taoyuan (TW)

(21) Appl. No.: 13/555,196

(22) Filed: Jul. 23, 2012

(30) Foreign Application Priority Data
Feb. 23, 2012 (TW) 101106065

(51) Int. Cl. G06F 3/041

(52) U.S. Cl. 345/173

(57) ABSTRACT

A touch display apparatus including a display panel, a touch panel, a gate driver and a touch sensor is provided. The touch panel is disposed corresponding to the display panel. The gate driver is coupled to the display panel and the touch panel so as to sequentially output a plurality of scan signals to the display panel and sequentially output a plurality of driver signals to the touch panel. Here, the output time of the scan signals and the output time of the driver signals are not overlapped. The touch sensor is coupled to the touch panel and calculates a touch position according to a sensor signal outputted by the touch panel.

### CROSS-REFERENCE TO RELATED APPLICATION

This application claims the priority benefit of Taiwan application serial no. 101106065, filed on Feb. 23, 2012. The entirety of the above-mentioned patent application is hereby incorporated by reference herein and made a part of this specification.

### BACKGROUND OF THE INVENTION

1. Field of the Invention

The invention relates to a touch display apparatus. More particularly, the invention relates to a touch display apparatus integrated with driving circuit.

2. Description of Related Art

The increasing progress of display technologies brings about great conveniences to people's daily lives. Flat panel displays (FPD) have gradually become the mainstream products in the display market due to their light-and-thin characteristics. Recently, various types of electronic products are developed along the line of easy operation, small volume, and large screen size. The requirements on the volume and the screen size of portable products are particularly demanding. Accordingly, a touch design and a display panel are integrated in many electronic products so that the space for disposing a keyboard or an operation button can be eliminated. Hence, the space available for disposing a screen can be enlarged.

Generally speaking, the touch display panel includes a display panel and a touch panel, wherein the touch panel can be built in or attached to the display panel. The touch panels are categorized into, according to the different sensing methods, a resistive touch panel, capacitive touch panel, optical touch panel, sonic touch panel, and electromagnetic touch panel. Moreover, due to modular design, the driving circuit of the display panel and the driving circuit of the touch panel are usually separated such that the driving circuits of the display panel and the driving circuits of the touch panel can be operated independently.

The touch panel is built in or attached to the display panel, so the sensing signal outputted by the touch panel is easily affected by the electric field of the display panel, such that the touch quality, for example, sensitivity, accuracy, etc., of the touch panel is affected. Currently, the touch quality of the touch panel can be improved by two following methods: first, adding a shielding layer on the touch panel for reducing the interference from the display panel to the touch panel such that the interference from the electric field of the display panel to the touch panel can be further decreased; secondly, raising the voltage levels of the driving signals of the touch panel to increase the signal to noise ratio (SNR) of the sensing signal of the touch panel. Although the methods mentioned above can reduce the interference from the display panel to the touch panel, the cost of the touch display apparatus is also increased.

### SUMMARY OF THE INVENTION

The present invention is directed to a touch display apparatus which generates the driving signals of the touch panel by the gate driver so as to increase the signal to noise ratio (SNR) of the sensing signal of the touch panel, and reduce the cost of the hardware. Also, by separating the output time of the scan signals and the output time of the driving signals, the interference from the electric field of the display panel to the touch panel is reduce.

The invention provides a touch display apparatus, which includes a display panel, a touch panel, a gate driver and a touch sensor is provided. The touch panel is disposed corresponding to the display panel. The gate driver is coupled to the display panel and the touch panel so as to sequentially output a plurality of scan signals to the display panel and sequentially output a plurality of driving signals to the touch panel, wherein the output time of the scan signals and the output time of the driving signals are not overlapped. The touch sensor is coupled to the touch panel and calculates a touch location according to a sensing signal outputted by the touch panel.

According to one embodiment of the present invention, the gate driver outputs the scan signals in sequence during a frame display period and the gate driver outputs the scan signals in sequence during a vertical blank period.

According to one embodiment of the present invention, a number of scanning the touch panel during the vertical blank period depends on a pulse width of the driving signals.

According to one embodiment of the present invention, the number of scanning the touch panel during the vertical blank period is 1.

According to one embodiment of the present invention, the gate driver includes a plurality of gate driving chips, wherein the gate driving chips respectively output part of the driving signals.

According to one embodiment of the invention, the gate driver includes a plurality of gate driving chips, wherein the driving signals are outputted by part of the gate driving chips.

According to one embodiment of the invention, the driving signals are outputted by a plurality of dummy pins of the gate driving chips.

According to one embodiment of the invention, the touch sensor determines the output time of each driving signal according to the timing so as to determine a first axial coordinate corresponding to the touch location according to the output time of each driving signal when the sensing signal is received, and determines a second axial coordinate corresponding to the touch location according to the output pins of the sensing signal.

According to one embodiment of the invention, the touch display apparatus further comprises a timing controller configured to control the gate driver to output the scan signals and the driving signals.

According to one embodiment of the invention, the touch display apparatus is integrated with the timing controller.

According to one embodiment of the invention, the touch panel is built in or attached to the display panel.

Based on the above, in the embodiments of the invention, the touch display apparatus outputs the driving signals by the gate driver to increase the SNR of the sensing signal and also reduce the cost of the hardware. Secondly, the output time of the scan signals and the output time of the driving signals are not overlapped, so the interference from the display panel to the touch panel can also be reduced.

Other features and advantages of the invention will be further understood from the further technological features disclosed by the embodiments of the invention wherein there are shown and described embodiments of this invention, simply by way of illustration of modes best suited to carry out the invention.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates a schematic system diagram of a touch display apparatus according to an embodiment of the invention.

FIG. 2 shows a schematic timing diagram of scan signals and driving signals according to an embodiment of the invention.

FIG. 3 shows a schematic layout diagram of a gate driver, a display panel and a touch panel in FIG. 1 according to an embodiment of the invention.

FIG. 4 shows a schematic layout diagram of a gate driver, a display panel and a touch panel in FIG. 1 according to another embodiment of the invention.

FIG. 5 illustrates a schematic system diagram of a touch display apparatus according to another embodiment of the invention.

### DESCRIPTION OF EMBODIMENTS

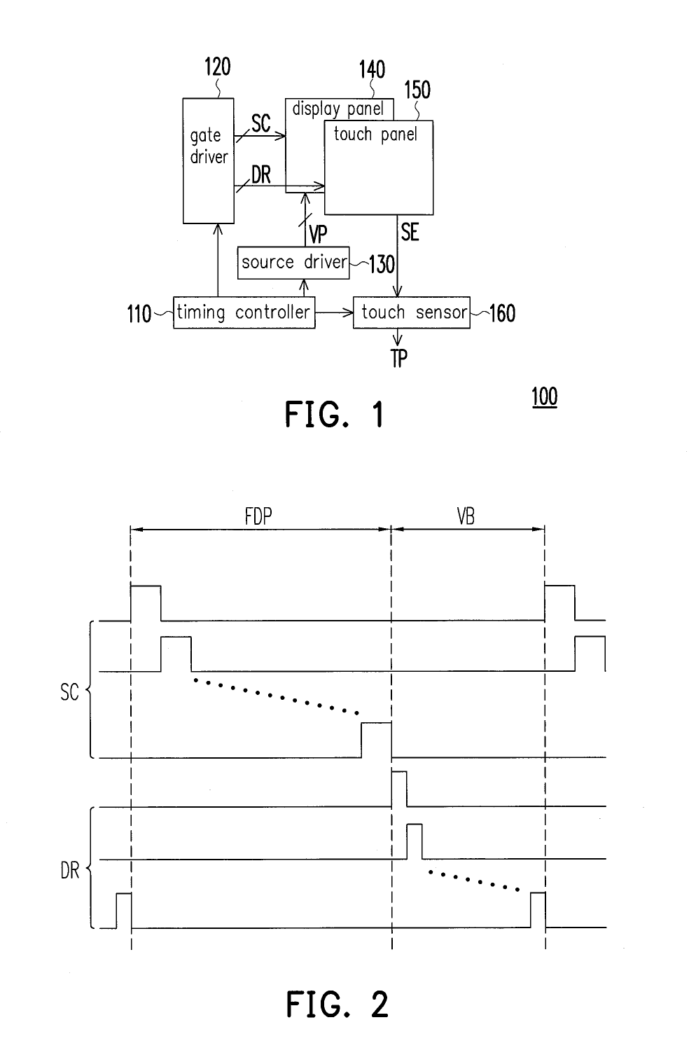

FIG. 1 illustrates a schematic system diagram of a touch display apparatus according to an embodiment of the invention. Referring to FIG. 1, in the present embodiment, a touch display apparatus 100 includes a timing controller 110, a gate driver 120, a source driver 130, a display panel 140, a touch panel 150 and a touch sensor 160. Generally speaking, the touch panel 150 is disposed corresponding to the display panel 140, which means the touch panel 150 can be built in or attached to the display panel 140. The disposition of the touch panel 150 depends on the components adopted by people skilled in the art. The invention is not limited thereto.

The timing controller 110 is coupled to the gate driver 120 and the source driver 130. The gate driver 120 is coupled to the display panel 140 and the touch panel 150, and is controlled by the timing controller 110 to sequentially output a plurality of scan signals SC to the display panel 140 and sequentially output a plurality of driving signals DR to the touch panel 150. The output time of the scan signals SC and the output time of the driving signals DR are not overlapped. The source driver 130 is coupled to the display panel 140 and is controlled by the timing controller 110 to sequentially output a plurality of pixel voltages VP to the display panel 140 for writing the image to be displayed into the display panel 140. The touch sensor 160 is coupled to the touch panel 150 and calculates a touch location TP according to a sensing signal SE outputted by the touch panel 150.

Accordingly, the voltage levels of the scan signals SC (around 20-30 volt) are much greater than the driving voltages of the conventional touch panel (around 3.3-5 volt), so the driving signals DR outputted by the gate driver 120 are also much greater than the driving voltages of the conventional touch panel. Therefore, the signal to noise ratio (SNR) of the sensing signal SE is increased and the circuit for generating the driving signals DR can be saved such that the cost of the hardware is reduced. Furthermore, the output time of the scan signals SC and the output time of the driving signals DR are not overlapped, which means the time of writing image to the display panel 140 and the time of scanning the touch panel 150 are not overlapped. When image is written to the display panel 140, the electric field of the display panel 140 is stronger, so scanning the touch panel 150 when image is not written to the display panel 140 can reduce the interference from the electric field of the display panel 140 to the touch panel 150.

To be more specific, the timing controller 110 can transmit a signal configured to control the gate driver 120, for example, vertical start signal, or transmit a corresponding timing signal to the touch sensor 160 such that the touch sensor 160 can obtain the signal output timing of the gate driver 120 through counting clocks, and the touch sensor 160 can determine the output time of each driving signal DR according to the signal output timing of the gate driver 120. Taking the touch panel 150 as a capacitive touch panel for example, each driving signal DR is outputted in sequence, so the output time of each driving signal DR determines an axial coordinate, such as Y-coordinate, of the touch location TP, and another axial coordinate, such as X-coordinate, of the touch location TP is determined according to the output pins of the sensing signal SE. Therefore, when receiving the sensing signal SE, the touch sensor 160 determines a first axial coordinate, such as Y-coordinate corresponding to the touch location TP according to the output time of each driving signal DR, and determines a second axial coordinate, such as X-coordinate, corresponding to the touch location TP according to the output pins of the sensing signal SE. Thereby, the required control signals for performing touch-scanning can be simplified.

In the present embodiment of the invention, the touch panel 150 is not limited to capacitive touch panel, and can be a touch panel which receives a plurality of driving signal DR in sequence and outputs the sensing signal SE to the corresponding pins according to the touch location, for example, a digital resistive touch panel.

FIG. 2 shows a schematic timing diagram of scan signals and driving signals according to an embodiment of the invention. Referring to FIG. 1 and FIG. 2, in the present embodiment, the gate driver 120 is controlled by the timing controller 110 to sequentially output a plurality of scan signals SC to the display panel 140 during the frame display period FDP, and sequentially output a plurality of driving signals DR to the touch panel 150 during the vertical blank period VB, which means a falling edge of the last scan signal SC triggers the gate driver 120 to start sequentially outputting a plurality of driving signals DR. The combination of the frame display period FDP and the vertical blank period VB can be seen as a frame period.

Generally, a number of scanning the touch panel 150 during the vertical blank period VB depends on the length of the vertical blank period VB, the amount of the driving signals DR required by the touch panel 150, and the pulse width of the driving signals DR. Under a circumstance that the vertical blank period VB and the amount of the driving signals DR required by the touch panel 150 are fixed, the number of scanning the touch panel 150 during the vertical blank period VB depends on the pulse width of the driving signals DR. That is to say, the wider the pulse width of the driving signals DR is, the less the number of scanning the touch panel 150 during the vertical blank period VB is, and the narrower the pulse width of the driving signals DR is, the more the number of scanning the touch panel 150 during the vertical blank period VB is, which can be decided by the people skilled in the art. Moreover, when the number of scanning the touch panel 150 during the vertical blank period VB gets more, the touch sensitivity gets higher, which can decided by people skilled in the art. The pulse width of the driving signals DR can be controlled by the timing controller 110, but other embodiments of the invention are not limited thereto.

Furthermore, when the number of scanning the touch panel 150 during the vertical blank period VB is greater than 1, the gate driver 120 repeatedly emits the driving signals DR, which means an extra control circuit is disposed in the gate driver 120 to trigger the gate driver 120 repeatedly emitting the driving signals DR. When the number of scanning the touch panel 150 during the vertical blank period VB is 1, which means each of the driving signals DR only outputs once during the vertical blank period VB, the gate driver 120 does not need to repeatedly emit the driving signals DR, which means the extra control circuit does not need to be disposed to trigger the gate driver 120 repeatedly emitting the driving signals DR, the circuit of the gate driver 120 thus can be simplified.

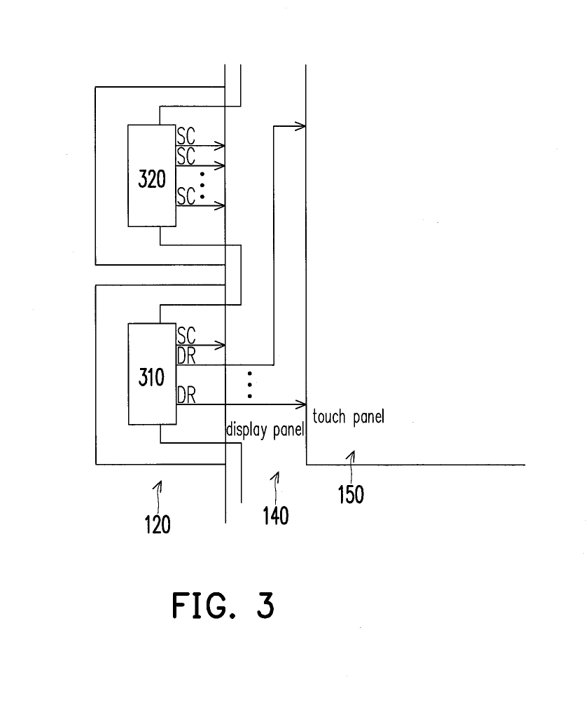

FIG. 3 shows a schematic layout diagram of a gate driver, a display panel and a touch panel in FIG. 1 according to an embodiment of the invention. Referring to FIG. 1 and FIG. 3, in the present embodiment, the touch panel 150 attached to the display panel 140 is illustrated. Also, the gate driver 120 has a plurality of gate driving chips (e.g. 310 and 320), the gate driving chips is configured to generate the scan signals SC, wherein the driving signals DR are outputted by part of the gate driving chips (e.g. 310). The amount of the gate driving chips configured to output the driving signals DR is determined according to the actual requirement. The figures are only used for illustration. Moreover, the gate driving chips (e.g. 310) can use the dummy pins thereof to output the driving signals DR, such that the function of outputting scan signals SC is not affected.

In the present embodiment, the driving signals DR can be transmitted to the touch panel 150 by extra circuit layout. The touch panel 150 is attached to the display panel 140, so the extra circuit can be formed on a surface opposing to the liquid crystal layer of a color filter substrate of the display panel 140.

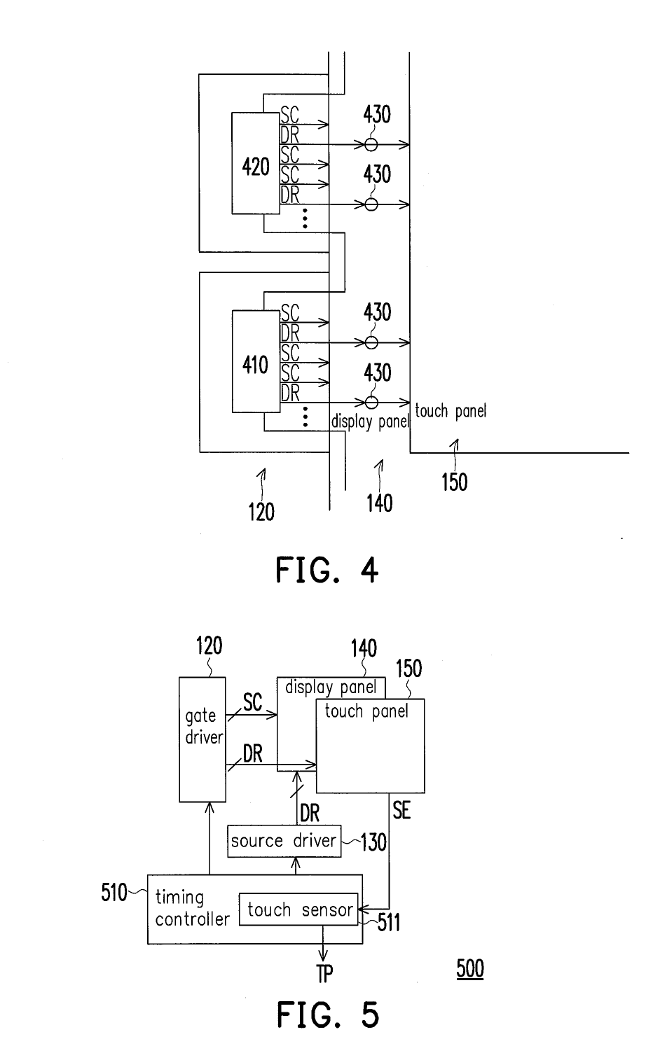

FIG. 4 shows a schematic layout diagram of a gate driver, a display panel and a touch panel in FIG. 1 according to another embodiment of the invention. Referring to FIG. 1 and FIG. 4, in the present embodiment, the touch panel 150 attached to the display panel 140 is illustrated. The gate driver 120 has a plurality of gate driving chips (e.g. 410 and 420), wherein the gate driving chips (e.g. 410 and 420) respectively output part of the driving signals DR, which means the gate driving chips (e.g. 410 and 420) not only output the scan signals SC but also output at least a driving signal DR, and the amount of the driving signals DR outputted by each of the gate driving chips (e.g. 410 and 420) would change according to the amount of the driving signals DR required by the scanned touch panel 150.

In the circumstance of the gate driving chips (e.g. 410 and 420) commonly outputting the driving signals DR, the driving signals DR is transmitted to the display panel 140 by the layout as the scan signals SC, then vias 430 can be formed on the display panel 140 so as to transmit the driving signals DR to the touch panel 150 through the corresponding via 430. Thereby, the paths of the driving signals DR transmitted to the touch panel 150 are similar, which means the power consumption of each driving signal DR transmitted by the gate driving chips (e.g. 410 and 420) to the touch panel 150 is approximately the same, so the voltage level of the sensing signal SE outputted by the touch panel 150 is approximately the same, which means the uniformity of the touch sensing can be improved, and the touch quality is enhanced.

FIG. 5 illustrates a schematic system diagram of a touch display apparatus according to another embodiment of the invention. Referring FIG. 1 and FIG. 5, the touch sensor 500 is approximately the same as the touch sensor 100 with a difference in the timing controller 510. In the present embodiment, the touch sensor 511 is integrated in the timing controller 510, wherein the touch sensor 511 can refer to the descriptions of the touch sensor 160 and thus will not be reiterated herein. Thereby, an extra touch sensor does not need to be disposed so the cost of the hardware can be reduced.

In the light of the foregoing, the touch display apparatus of the invention outputs the driving signals by the gate driver to increase the SNR of the sensing signal and save the circuit for generating the driving signals so the cost of the hardware is reduced. Secondly, the output time of the scan signals and the output time of the driving signals are not overlapped, so the interference from the display panel to the touch panel can also be reduced. Moreover, the touch sensor can determine the output time of each driving signal according to the signal output timing of the gate driver, such that the required control signals for performing touch-scanning can be further simplified. Furthermore, the gate driving chips can commonly output the driving signals such that the paths of the driving signals transmitted to the touch panel are similar, so as to increase the uniformity of the touch sensing and further enhance the touch quality. Also, the touch sensor can be integrated with the timing controller, such that an extra touch sensor is no need to be disposed so the cost of the hardware can be reduced.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A touch display apparatus comprising:
a display panel;
a touch panel, disposed corresponding to the display panel;
a gate driver, coupled to the display panel and the touch panel so as to sequentially output a plurality of scan signals to the display panel and sequentially output a plurality of driving signals to the touch panel, wherein the output time of the scan signals and the output time of the driving signals are not overlapped; and
a touch sensor, coupled to the touch panel and calculates a touch location according to a sensing signal outputted by the touch panel.

2. The touch display apparatus of claim 1, wherein the gate driver outputs the scan signals in sequence during a frame display period and the gate driver outputs the driving signals in sequence during a vertical blank period.

3. The touch display panel as claimed in claim 2, wherein a number of scanning the touch panel during the vertical blank period depends on a pulse width of the driving signals.

4. The touch display panel as claimed in claim 2, wherein a number of scanning the touch panel during the vertical blank period is 1.

5. The touch display apparatus as claimed in claim 1, wherein the gate driver includes a plurality of gate driving chips, wherein the gate driving chips respectively outputs part of the driving signals.

6. The touch display apparatus as claimed in claim 1, wherein the gate driver includes a plurality of gate driving chips, wherein the driving signals are outputted by part of the gate driving chips.

7. The touch display apparatus as claimed in claim 1, wherein the driving signals are outputted by a plurality of dummy pins of a plurality of gate driving chips.

8. The touch display apparatus as claimed in claim 1, wherein the touch sensor determines an output time of each driving signal according to the timing so as to determine a first axial coordinate corresponding to the touch location according to the output time of each driving signal when the sensing signal is received, and determines a second axial coordinate corresponding to the touch location according to an output pin of the sensing signal.

9. The touch display apparatus as claimed in claim 1 further comprises a timing controller configured to control the gate driver to output the scan signals and the driving signals.

10. The touch display apparatus as claimed in claim 9, wherein the touch sensor is integrated with the timing controller.

11. The touch display apparatus as claimed in claim 1, wherein the touch panel is built in the display panel or attached to the display panel.
